(19) United States
(12) Patent Application Publication
(10) Pub. No.: US 2009/0323091 A1
(43) Pub. Date: Dec. 31, 2009

(54) RENDERING CONTROL DEVICE, RENDERING DEVICE AND PROGRAM FOR RENDERING CONTROL

(75) Inventor: Masatoshi Adachi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: Pioneer Corperation, Merguro-ku, Tokyo (JP)

(21) Appl. No.: 12/515,876

(22) PCT Filed: Nov. 22, 2006
(86) PCT No.: PCT/JP2006/323357

§ 371 Date: May 21, 2009

(51) Int. Cl. H04N 1/60; G06K 15/00

(52) U.S. Cl. 358/1.9; 358/1.18

(57) ABSTRACT

A rendering control device capable of creating a rendering of a visible image perceived from a rendered visible image that best matches visual expectations of a rendering person as compared with its original image is provided.

A rendering system S which controls an optical rendering on an optical disk DK of a visible image visually recognizable from outside the optical disk DK acquires discoloration information indicating a change in visual color on the optical disk DK by the rendering, and includes a CPU 4 which controls the rendering based on the discoloration information and image information corresponding to the visible image.

### TECHNICAL FIELD

The present application pertains to a technical field of a rendering control device, a rendering device, and a program for rendering control, and in particular, pertains to a technical field of a rendering control device and a program for rendering control that control optical rendering on a recording medium such as an optical disk of a visible image visually recognizable from outside the recording medium and a rendering device including the rendering control device.

### BACKGROUND ART

In recent years, for optical discs such as CD-R (Compact Disc-Recordable) and DVD-R (Digital Versatile Disc-Recordable), an optical disk recording device (optical disk drive device) capable of rendering a visible image such as characters and patterns separately from original recorded information such as images and music to be reproduced so as to be visually recognizable from outside is provided.

Such an optical disk recording device is configured to render the visible image by irradiating the optical disk with a laser light to optically cause denaturation of color in a discoloration layer visually recognizable from outside and using characters, patterns and the like that appear due to the denaturation (See, for example, Patent Document 1 below).

Patent Document 1: Japanese Patent Application Laid-Open No. 2002-203321

### DISCLOSURE OF THE INVENTION

### Problems to be Solved by the Invention

In a rendering of a visible image on the optical disk, on the other hand, due to differences of constitution and composition of the discoloration layer contributing to rendering of the visible image, both the color shade in a non-rendered portion in which the visible image is not rendered and the color shade in a rendered portion in which the visible image is rendered are different from optical disk to optical disk (more specifically, from manufacturer to manufacturer of the optical disk, from composition to composition of the discoloration layer, and from composition to composition of a reflecting layer constituting the optical disk). Particularly in a rendering of a visible image on a data recording surface on which the recorded information is recorded, the composition or the like of the discoloration layer contributing to the rendering is designed by giving priority to improvement of recording characteristics of the recorded information and thus, changes in the color shade may even be inappropriate for visible image recording.

Therefore, even if visible image rendering processing is performed in the same mode base on the same specifications (more specifically, the same optical beam intensity) on optical disks having different discoloration layer constitutions using the same optical disk recording device, there is a problem that the mode (image) of the visible image obtained after the rendering processing will be different from the mode intended by a person who attempted to render the visible image and, according to circumstances, light and shade in a rendered visible image may even be rendered as if light and shade were inverted from that intended by the person.

The present application is filed in view of the above problem and an example of the object thereof is to provide a rendering control device, a rendering device, and a program for rendering control capable of performing a rendering visually best matching rendering person's expectations when a visual image perceived from a rendered visual image and an original image from which the rendering originates are compared.

### Means for Solving the Problems

In order to solve the above problems, the invention according to claim 1 relates to a rendering control device which controls optical rendering on a recording medium of a visible image visually recognizable from outside the recording medium, comprising:

acquisition means for acquiring discoloration information indicating a change of visual color on the recording medium by the rendering; and

control information generating means for generating control information to control the rendering based on the acquired discoloration information and image information corresponding to the visible image to be provided to the rendering.

In order to solve the above problems, the invention according to claim 9 relates to the rendering control device according to any one of claims 1 to 6, further comprising

discoloration information storage means for storing the discoloration information corresponding to the rendering control device in advance, wherein

the acquisition means is reading means for reading the discoloration information from the discoloration information storage means.

In order to solve the above problems, the invention according to claim 10 relates to a rendering device, comprising:

acquisition means for acquiring the control information generated by the rendering control device according to any one of claims 1 to 7 or 9; and

emission means for emitting a light beam for the rendering based on the acquired control information.

### BRIEF DESCRIPTION OF THE DRAWINGS

FIG. 1 is a block diagram showing an outline configuration of a rendering system according to an embodiment.

FIGS. 2A and 2B are diagrams exemplifying concrete examples of discoloration information according to the embodiment, and FIG. 2A is a diagram showing a first example of the discoloration information and FIG. 2B is a diagram showing a second example of the discoloration information.

FIG. 3 is a flow chart showing rendering processing according to the embodiment.

### EXPLANATIONS OF LETTERS OR NUMERALS

1 Control device
4, 13 CPU
5 Display
10 Rendering device
11 Pickup
16 Encoder
12 Recording pulse generation part
100, 200 Discoloration information
101 Color information before rendering
110 Color information after rendering
201 First intermediate color information
202 Second intermediate color information
203 Third intermediate color information
S Rendering system
DK Optical disk

### BEST MODE FOR CARRYING OUT THE INVENTION

Next, the best mode for carrying out the present application will be described based on drawings. The embodiment described below is an embodiment when the present application is applied to an image rendering system that optically renders a visible image on an optical disk formed with the discoloration layer so that the visible image can be rendered.

### (I) Principle of the Present Application

First, the principle of the present application will be described before describing a concrete embodiment.

In rendering processing of a visible image on the optical disk, like a technology disclosed by the above Patent Document 1, a discoloration portion visually recognizable from outside is commonly formed in a discoloration layer by intermittently irradiating the discoloration layer formed in the optical disk with a light beam or the like. Then, a rendering result recognizable as a visible image by a person is obtained on the optical disk in accordance with the degree of color change ranging from the color of the discoloration layer in a state in which the light beam or the like is not shone on the discoloration layer to that of the discoloration layer in a state in which the discoloration has sufficiently progressed by the discoloration layer being irradiated with the light beam.

In this case, as described above, the color of the discoloration layer before the discoloration and the color of the discoloration layer after the discoloration are diverse depending on the constitution and composition of the discoloration layer used and, for example, the so-called hue of some discoloration layers changes between before the discoloration and after the discoloration, and only the so-called lightness of other discoloration layers changes between before the discoloration and after the discoloration. Further, colors themselves before the discoloration and after the discoloration are diverse.

Here, when a visible image is rendered, the visible image to be rendered is commonly edited as a monochrome image (monotone image) in most cases and, in this case, 100% “white” is allocated to the color before the discoloration and 100% “black”, on the other hand, is allocated to the color in a state in which the discoloration has sufficiently progressed, and details of a visible image are rendered as gray scale representations of color therebetween. Thus, a design as a visible image that is adequately legible for a rendering person during editing could sometimes become an unclear pattern when a result of actual rendering is viewed.

Thus, in the present application, the optical disk is caused to record discoloration information showing exterior color changes of a discoloration layer as a result of the discoloration layer being irradiated with the light beam or the like in advance. Then, by using the discoloration information by reading the information from the optical disk before a visible image being rendered, a difference between a finished visible image expected by the rendering person and an actually rendered visible image is minimized and also rendering visually less awkward to the rendering person is enabled.

### (II) Embodiment

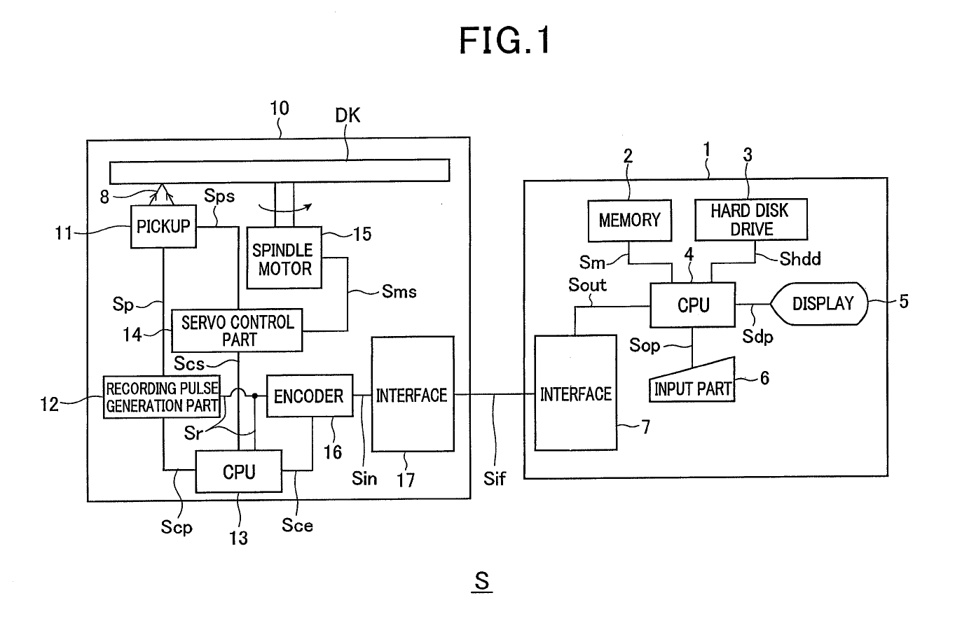

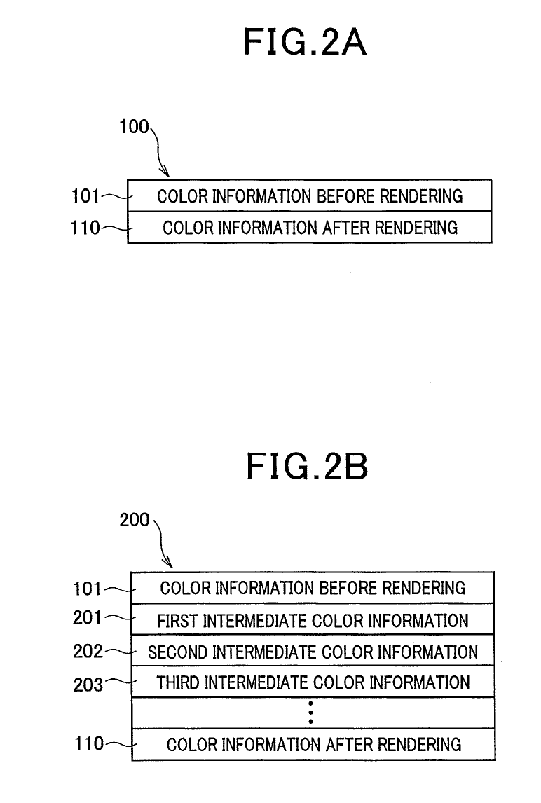

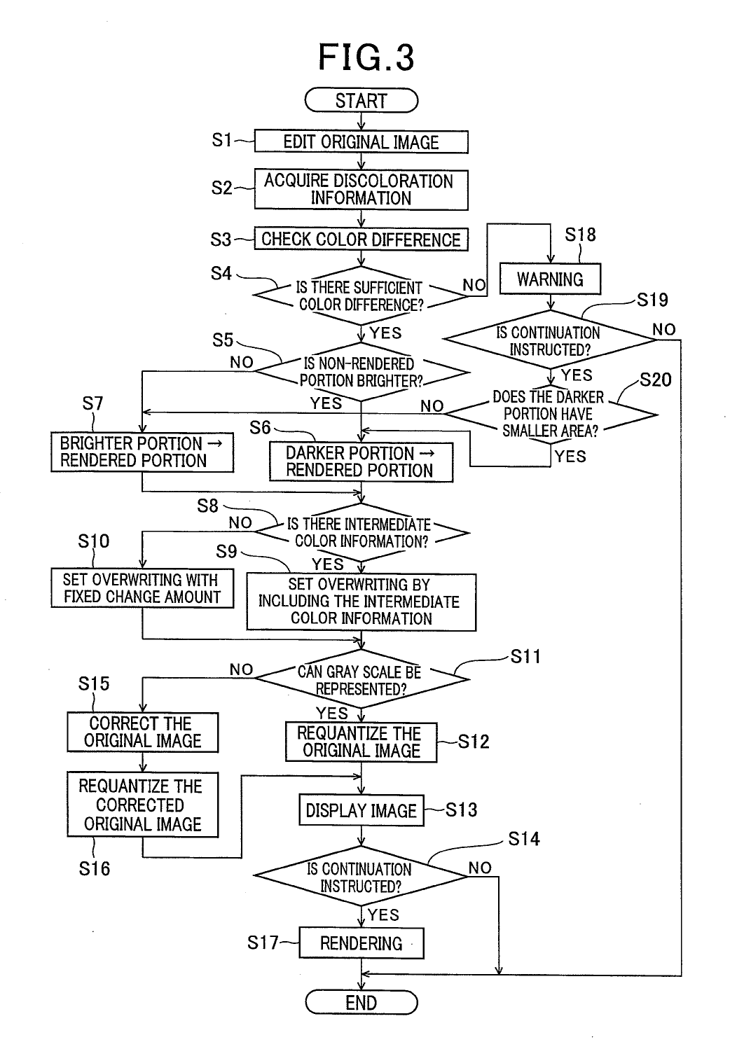

Next, the embodiment according to the present application will be described concretely with reference to FIGS. 1 to 3. FIG. 1 is a block diagram showing an outline configuration of a rendering system according to the embodiment, FIG. 2 is a diagram exemplifying content of discoloration information according to the embodiment, and FIG. 3 is a flow chart showing rendering processing of a visible image according to the embodiment.

As shown in FIG. 1, a rendering system S according to the embodiment includes a rendering device 10 that has the discoloration layer and actually performs rendering processing according to the embodiment on an optical disk DK in which discoloration information is recorded, for example, in a read-in area in advance and a control device 1 that controls a rendering operation in the rendering device 10. Here, the rendering system S is actually configured, for example, as a personal computer as a whole and the rendering device 10 is configured as an optical disk drive device in the personal computer.

In this configuration, the control device 1 includes a memory 2, a hard disk drive 3, a CPU 4 as control information generation means, comparison means, gray scale determination means, and image information correction means, a display 5 as display means made up of a liquid crystal display or the like, an input part 6 made up of a keyboard and mouse, and an interface 7 as acquisition means.

The rendering device 10 is composed of, on the other hand, a pickup 11 as emission means for emitting a light beam B for the rendering to a discoloration layer (not shown) in the optical disk DK and as acquisition means, a recording pulse generation part 12, a CPU 13, a servo control part 14, a spindle motor 15 that causes the optical disk DK to rotate at a preset rotating speed, an encoder 16, and an interface 17.

Next, outline operations of each device will be described.

First, an outline operation of the control device 1 will be described.

The CPU 4 inside the control device 1 reads original image information Shdd corresponding to an original image to be a source of a visible image to be rendered on the optical disk DK from a hard disk (not shown) contained in the hard disk drive 3.

Then, rendering processing of a visible image according to the embodiment described later is performed based on an operation signal Sop output from the input part 6 based on an operation of a rendering person in the input part 6 to generate a visible image information Sout corresponding to the visible image to be rendered before being output to the interface 7.

Information necessary for performing the rendering processing is temporarily stored in the memory 2 as a memory signal Sm, which is reread as the memory signal Sm when necessary before being provided to the rendering processing.

Confirmation processing of a visible image while the rendering processing being performed is performed by a person who performs the rendering processing using the display 5 driven by a display signal Sdp from the CPU 4.

The interface 7 into which the visible image information Sout is input performs output interface processing preset to the visible image information Sout and outputs the visible image information Sout as an interface signal Sif to the interface 17 of the rendering device 10.

The discoloration information recorded in the optical disk DK is read by the rendering device 10 from the optical disk DK in advance and incorporated into the CPU 4 via the interfaces 17 and 7 before being provided to rendering processing described later.

Next, an outline operation of the rendering device 10 will be described.

The interface 17 into which the interface signal Sif is input performs input interface processing preset to the interface signal Sif and generates input information Sin corresponding to the visible image information Sout, which is output to the encoder 16.

Accordingly, the encoder 16 encodes the input information Sin based on a control signal Sce from the CPU 13 and outputs the encoded input information Sin as encoded rendering information Sr to the recording pulse generation part 12 and the CPU 13.

Then, the recording pulse generation part 12 generates a recording pulse signal Sp for intensity control of the light beam B from the encoded rendering information Sr based on a control signal Scp from the CPU 13 and outputs the recording pulse signal Sp to a semiconductor laser (not shown) in the pickup 11. At this point, the recording pulse generation part 12 generates the recording pulse signal Sp in such a way that intensity of the light beam B changes depending on an irradiation position thereof so that a visible image input as the input information Sin is rendered as discoloration of the discoloration layer in the optical disk DK.

Accordingly, the pickup 11 irradiates the optical disk DK with the light beam B for rendering in accordance with intensity and timing indicated by the recording pulse signal Sp.

The irradiation position of the light beam B is determined by movement of an objective lens (not shown) (that is, an objective lens for condensing the light beam B) in the pickup in a direction parallel to the discoloration layer in the optical disk DK based on a pickup servo signal Sps from the servo control part 14 controlled by a control signal Scs from the CPU 13 and changes in rotation mode of the spindle motor 15 based on a spindle servo signal Sms from the servo control part 14.

Then, the CPU 13 generates each of the control signals Sce, Scp, and Scs to make an actual visible image rendered by controlling the irradiation position and intensity of the light beam B based on the encoded rendering information Sr output from the encoder 16 and outputs the generated control signals Sce, Scp, and Scs to the encoder 16, the recording pulse generation part 12, and the servo control part 14 respectively.

Next, the discoloration information according to the embodiment will be described by exemplification concretely using FIG. 2.

As shown in FIGS. 2A and 2B, there are two kinds of discoloration information 100 and 200 as discoloration information according to the embodiment. Either the discoloration information 100 or 200 is recorded in advance in accordance with characteristics of the discoloration layer formed inside the optical disk DK.

As shown in FIG. 2A, the discoloration information 100 contains only color information before rendering 101 indicating the exterior color of the optical disk DK before the light beam B is shone and color information after rendering 110 indicating the exterior color of the optical disk DK after, as a result of a necessary amount of the light beam B being shone, discoloration of the discoloration layer has progressed far enough to a (for example, empirically) preset progress degree.

In contrast, the discoloration information 200 contains, as shown in FIG. 2B, in addition to the color information before rendering 101 and the color information after rendering 110 like the discoloration information 100, first intermediate color information 201, second intermediate color information 202, third intermediate color information 203 and the like which gradually indicate exterior colors of the optical disk DK in intermediate states of changes in stages from the color before rendering indicated by the color information before rendering 101 to the color indicated by the color information after rendering 110.

Here, if it is assumed for brevity of description that the gray scale represented on the optical disk DK is determined only by the number of times of overwriting by the light beam B, the discoloration information 100 or 200 can be recorded in the optical disk DK as coordinate position data in a so-called CIE L*a*b (Commission Internationale de l'Eclairage Luminescence alpha beta) color space.

In addition, for an optical disk DK that assumes to increase the number of times of overwriting to obtain adequate discoloration, it becomes possible to estimate the number of times of overwriting necessary to obtain adequate discoloration when the actual rendering device 10 is used by recording also information of the number of times indicating the number of times of overwriting by a so-called standard recorder necessary to obtain adequate discoloration.

For the discoloration information 200, if the number of times of overwriting when the discoloration layer has adequately discolored is, for example, eight times, color information when overwritten twice, color information when overwritten four times, and color information when overwritten six times may be recorded as intermediate color information.

Here, since color coordinates do not change linearly with respect to a change of the number of times of overwriting for many optical disks DK, a more faithful finished visible image can be obtained if intermediate color changes can be recorded like the discoloration information 200.

Next, rendering processing according to the embodiment performed by using the rendering device 10 and the control device 1 on the optical disk DK on which the discoloration information 100 or 200 exemplified in FIG. 2A or 2B respectively is recorded in advance will be described more specifically using FIG. 3.

In rendering processing according to the embodiment, as shown in FIG. 3, an image to be rendered on an optical disk DK is first edited as an original image on the control device 1 side (step S1). If the optical disk DK on which the image is rendered is already inserted in the rendering device 10, after reading the discoloration information 100 or 200 recorded thereon in advance, the discoloration information may be reflected in the image being edited.

Here, various kinds of mode of the editing processing can be considered and, for example, the color difference as an original image can daringly be edited to be represented only by monochrome gray scale representations. The color difference is daringly edited in monochrome because the display 5 used for editing is not adjusted to display the correct color as the original image in most cases and thus, if the original image is attempted to be edited in color display, there is a possibility that a wrong impression is given as the impression of the original image.

Next, when editing as the original image is completed, the discoloration information 100 or 200 recorded on the optical disk DK is read therefrom by the rendering device 10 (step S2).

Next, based on the read discoloration information 100 or 200, a rendering state in which the color is easily perceived as visually bright (that is, one of a non-rendered state and rendered state) is determined (steps S3 and S4).

Here, if the discoloration information 100 or 200 is described as coordinate position data in the CIE L*a*b color space, concrete processing at step S3 is, for example, to first calculate a difference of two colors (that is, two colors of the color of the optical disk DK in a non-rendered state and that of the optical disk DK in a rendered state) only in the L coordinate direction and if, as a result, a significant difference is recognized, to determine the color with a “+” L coordinate to be the brighter color.

If, on the other hand, no significant difference in brightness is recognized in processing at step S3, next the chroma of the two colors is compared and if, as a result, a significant difference is recognized, the color with a higher chroma is determined to be the brighter color.

Further, if no sufficiently significant difference in both brightness and chroma is recognized, the difference in hue with respect to the direction in which

value in an a axis:value in a b axis=1:1

is represented in the range of ±180° and if a significant difference of absolute values thereof is recognized, the color with a smaller absolute value is determined to be the brighter color.

Lastly, if no sufficiently significant difference in hue with respect to the direction

value in an a axis:value in a b axis=1:1

described above is recognized, absolute values of difference in hue are similarly calculated for the b axis and if a significant difference of absolute values thereof is recognized, the color with a smaller absolute value is determined to be the brighter color.

While the brighter color is determined using the discoloration information 100 or 200 originally recorded in the optical disk DK in processing at steps S3 and S4, the embodiment is not limited to this and, for example, information indicating which of a non-rendered portion and a rendered portion the brighter color is may be recorded in the optical disk DK in advance.

If the color difference is determined to be sufficient by processing at steps S3 and S4 (step S4; YES), next whether or not a portion corresponding to the brighter color of the color difference is a non-rendered portion on which the light beam B is not shone is checked (step S5). If the portion corresponding to the brighter color of the color difference is accordingly a non-rendered portion (step S5; YES), a darker portion in the original image is determined to be a portion that should be rendered by shining the light beam B (step S6) before proceeding to processing at step S8 described later. If, on the other hand, the portion corresponding to the brighter color of the color difference is a rendered portion in the determination at step S5 (step S5; NO), a brighter portion in the original image is determined to be a portion that should be rendered by shining the light beam B (step S7) before proceeding to processing at step S8 described later.

With processing at steps S5 to S7 described above, a region on the optical disk DK where the brighter color determined by processing at steps S3 and S4 should be rendered as a white portion of the original image (in other words, a region in the original image) is determined.

After the region to be rendered is determined, next whether or not the information recorded on the optical disk DK is the discoloration information 200 is checked (step S8). If the information recorded on the optical disk DK is not the discoloration information 200, but the discoloration information 100 (step S8; NO), a color difference between the color indicated by the color information before rendering 101 contained in the discoloration information 100 and the color indicated by the color information after rendering 110 and the result thereof is divided by the number of times of overwriting necessary to reach the rendered state to estimate a color difference per time of overwriting (step S10) before proceeding to processing at step S11 described later.

The number of times of overwriting necessary to reach the rendered state may be recorded, for example, in the optical disk DK together with the discoloration information 100 or can be determined by defining a result of overwriting a predetermined number of times as a rendered color information value.

If, on the other hand, the information recorded on the optical disk DK is the discoloration information 200 in the determination at step S8 (step S8; YES), a color state per time of overwriting is set by making corrections in the amount of change per time of overwriting using intermediate color information exemplified in FIG. 2B (step S9) before proceeding to processing at step S11 described later.

Here, if it is assumed for brevity of description that only brightness changes, brightness when not rendered is 10% (See reference numeral 101 in FIG. 2B) and a rendered state is reached after overwriting eight times so that brightness is 90% (See reference numeral 110 in FIG. 2B) as concrete processing at step S9, it can be determined that brightness changes by 15 per time of overwriting up to four times and further changes by 5% per time of overwriting thereafter if, in addition, intermediate color information that brightness becomes 70% after overwriting four times can be obtained as a portion of the discoloration information 200. In this case, since the degree of change in color does not actually change significantly between the fourth overwriting and the fifth overwriting, it is desirable to interpolate therebetween using finer intermediate color information.

With processing at steps S1 to S10 described above, the gray scale that can be represented by overwriting using the optical beam B will be defined.

Next, whether or not the defined gray scale can all be represented by discoloration of the optical disk DK by irradiation of the light beam B is checked (step S11). That is, if the range of colors that can be represented by discoloration of the optical disk DK is equal to or larger than the range of colors contained in the original image and, as a result, intermediate gray scales contained in the defined gray scale of the original image can be adequately represented using gray scales that appear in the process of discoloration of the optical disk DK (step S11; YES), original image information Shdd corresponding to the original image is directly requantized by the gray scale indicated by the discoloration information 100 or 200 (that is, the gray scale that can be represented by discoloration of the optical disk DK) (step S12) before proceeding to processing at step S13 described later.

If, on the other hand, the defined gray scale cannot be all represented by discoloration of the optical disk DK in the determination at step S11, that is, the range of colors that can be represented by discoloration of the optical disk DK is smaller than that of colors contained in the original image and, as a result, intermediate gray scales contained in the defined gray scale of the original image cannot be represented using gray scales that appear in the process of discoloration of the optical disk DK (step S11; NO), the original image information Shdd is corrected in such a way that the darkest portion and the brightest portion of the original image become both ends of color change by recording when the original image is, for example, a monochrome image (step S15). Then, the corrected original image information Shdd is requantized by a gray scale that can be represented by discoloration of the optical disk DK (step S16) before proceeding to processing at step S13 described later. If, on the other hand, the original image is a color image, the color image is temporarily converted into a monochrome image in correction processing at step S15 and then, correction processing similar to the processing on a monochrome image described above may be performed.

In processing at step S12 or S16, if the optical disk DK is an optical disk formed to be able to reproduce color information by a plurality of discoloration layers, it is possible that components corresponding to each discoloration layer of the range of colors of the original image is extracted to requantize the original image information by gray scales than can be represented by discoloration of each discoloration layer.

When requantization by the processing at step S12 or S16 is completed, next an image as a result of the requantization is displayed in the display 5, for example, each time the image is overwritten (step S13) to make the rendering person check the state thereof.

Processing at step S13 is performed because, for example, when a color difference between a non-rendered state and a rendered state is large and the number of times of overwriting is small, the color difference per time of overwriting becomes large and if the color difference is a color difference beyond a range visually perceivable by the rendering person, a so-called pseudo contour is expected to appear in the finished visible image. The number of times of overwriting is naturally a natural number and thus, the possibility that all the number of gray scales of the original image cannot be represented intrinsically resides. Thus, the display 5 is caused to display an image after requantization by processing at step S13 to make the rendering person check content thereof.

Since positions in an image where the pseudo contour may appear are frequently predictable, it is possible to perform processing so as to blur edges of the pseudo contour by adding modulation to an original image separately from the number of times of overwriting according to the embodiment when the original image is edited.

When an image after requantization is displayed, whether or not an instruction to actually render the image has been issued by the rendering person is checked (step S14) and if such an instruction has been issued (step S14; YES), the visible image information Sout corresponding to the requantized image is output from the control device 1 to the rendering device 10 to cause the rendering device 10 to actually perform rendering processing (step S17) before the rendering processing according to the embodiment being terminated. If, on the other hand, such an instruction has not been issued in the determination at step S14 (step S14; YES), desired rendering is considered not executable in the range of processing that can be performed by the current control device 1 and the rendering processing according to the embodiment is immediately terminated.

If, on the other hand, the color difference is determined to be insufficient (that is, the brighter color cannot be determined) even with processing at steps S3 and S4 in the determination at step S4 (step S4; NO), it is not possible to render a desired visible image on the optical disk DK currently inserted in the rendering device 10 and thus, the rendering person is notified of a message to that effect (step S18).

If the person stops rendering due to the notification (step S19; NO), the rendering processing according to the embodiment is immediately terminated. If, on the other hand, continuation of rendering is instructed even if the notification is made (step S19; YES), this means that a region where rendered by shining the light beam B makes little difference in quality as a finished visible image regardless of a brighter portion or a darker portion of the original image and so, an area of the darker portion in the original image and that of the brighter portion are compared (step S20) to suppress energy consumption such as intensity of the light beam B necessary for recording to a minimum and a portion having a smaller area is determined as a rendering region before proceeding to step S6 (when the brighter portion has a smaller area (step S20; YES)) or step S7 (when the darker portion has a smaller area (step S20; NO)).

According to rendering processing by the control device 1 and the rendering device 10 according to the embodiment, as described above respectively, the discoloration information 100 or 200 indicating a change in visual color caused by rendering on an optical disk DK is acquired and the rendering is controlled based on the acquired discoloration information 100 or the like and visible image information Shdd corresponding to a visible image and thus, a rendering can be performed so that the visible image after rendering best matches visual expectations by adjusting to attributes of the optical disk DK such as a change in color by the rendering on the optical disk DK.

If it is inappropriate to render a visible image in connection with a color difference before and after rendering (See step S18 in FIG. 3), a notification to that effect is made and thus, a person who performs the rendering can determine alone whether to continue the rendering as it is.

Further, if continuation of rendering is instructed when the optical disk DK is determined to be inappropriate for the rendering (See step S19 in FIG. 3; YES), control is exercised in such a way that a visible image is rendered by shining the light beam B on a region on the optical disk DK corresponding to a darker portion or brighter portion of the visible image to be rendered having a smaller area (See step S20 in FIG. 3) so that the time necessary for rendering of the visible image or power for irradiation of the optical beam B can be saved.

Further, at least one of intensity of the light beam B for rendering and the number of times of rendering for the same position is controlled based on the intermediate color information 201 and the like contained in the discoloration information 200 and thus, a visible image with less sense of discomfort can be rendered by representing intermediate colors in the visible image appropriately.

If it is determined that the gray scale in a visible image to be rendered cannot be represented by a change within the range of the change in color indicated by the discoloration information 100 or the like (See step S11 in FIG. 3; NO), visible image information Shdd corresponding to the visible image is corrected and rendering is performed based on the corrected visible image information (See steps S15 and S16 in FIG. 3) and thus, the visible image can be rendered even if a gray scale of the visible image corresponds to a color beyond the range of the change in color on the optical disk DK.

Further, a visible image is displayed in the display 5 before being rendered (See step S13 in FIG. 3) and thus, the actual rendering can be caused to perform after checking content of a visible image to be rendered on the optical disk DK.

Further, the discoloration information 100 or the like corresponding to each optical disk DK is recorded on the optical disk DK itself and also such information is detected from the optical disk DK and thus, rendering of a clear visible image can be caused to perform by using the discoloration information 100 or the like optimized to and recorded on each optical disk DK.

### (III) Modifications

Next, various modifications according to the present application will be described.

First, as a first modification, while the brighter color when rendering a visible image using a normal color demonstration under so-called natural light is determined in processing at steps S3 and S4 in the above embodiment. However, if the color demonstration does not match the normal color demonstration, for example, when applied to a use in which a visible image appears only if a reference light of a specific wavelength is shone, the rendering processing in the embodiment can be applied unchanged to rendering processing of a visible image that is caused to appear by the reference light of the specific wavelength by recording a non-rendered state and a rendered state defined as brightness 100% and brightness 0% respectively on an optical disk DK.

Next, as a second modification, if discoloration characteristics of an optical disk DK cannot be determined because the optical disk DK to be rendered is not yet inserted in the rendering device 10 while an original image is edited, the original image may be edited based on the gray scale from while 100% to black 100% so that, after the optical disk DK is inserted into the rendering device 10, the original image and an expected rendering result are represented in a contrasting fashion.

Further as a third modification, a visible image closer to a desired one can be obtained by performing rendering with variable ratios of discolored region within a range of sufficiently small gradient or performing irradiation of the light beam B with weaker intensity at a time. In the former case, the ratio of discolored region can generally be calculated by changing the degree of colors before and after discoloration. The latter case can be realized both by determining intensity by trial overwriting using the rendering device 10 and recording more detailed information about color changes in the optical DISK in advance.

In the latter case, when the density of the visible image is adjusted by performing trial overwriting using the rendering device 10, the light source used for evaluating the trial overwriting is usually the same as that of the light beam B used for rendering and the light beam B has a single wavelength so that the contrast thereof does not necessarily match that viewed by human eyes. Therefore, an effective trial overwriting result can be obtained by storing numeric values showing a relationship between contrast changes detected by some wavelength and actual color changes.

Further as a fourth modification, the above embodiment is configured to record the discoloration information 100 or the like on an optical disk DK, but discoloration information provided for various kinds of optical disks including the above may be described in the CPU 13 in the rendering device 10, the CPU 4 in the control device, or a write application program for controlling the rendering device 10 to perform the rendering processing according to the embodiment using the discoloration information.

In this case, dislocation information provided for the rendering device 10 or the like is stored in advance and thus, rendering of a clear visible image can be caused to perform by using the discoloration information optimized to the rendering device 10 or the like and stored in advance.

Lastly, as a fifth modification, a visible image is rendered using only one light beam B in the above embodiment. However, in addition to this, if an optical disk from which rendered states of a plurality of colors are obtained using light beams of a plurality of wavelengths is used, rendering processing similar to that in the embodiment can be applied to each rendered state. In this case, when the brighter color is determined (steps S3 and S4) in the rendering processing according to the above embodiment, a rendering state corresponding to the brighter color may be determined among the plurality of rendered states.

As an optical disk from which rendered states of a plurality of colors are obtained by rendering using light beams of a plurality of wavelengths, in addition to an optical disk whose discoloration state is different depending on the wavelength of a light beam shone on a discoloration layer, an optical disk having discoloration layers formed in layers can be considered in which, after the discoloration layer on the surface side is caused to discolor by a light beam of some wavelength, a discoloration layer thereunder (the opposite side to the irradiation side of the light beam) is caused to discolor by a light beam of another wavelength. In this case, rendering regions for discoloration layers in the second and subsequent layers will be added to the rendering region of the first layer determined by the above rendering processing.

A program corresponding to the flow chart shown in FIG. 3 may be recorded in an information recording medium such as a flexible disk and hard disk or acquired via the Internet or the like and recorded to read and execute the program by a general-purpose computer so that the computer can be used as the CPUs 4 and 13 according to the embodiment or modifications.

1-11. (canceled)

12. A rendering control device which controls optical rendering on a recording medium of a visible image visually recognizable from outside the recording medium, comprising:
an acquisition device which acquires discoloration information indicating a change of visual color on the recording medium by the rendering; and
a control information generating device which generates control information to control the rendering based on the acquired discoloration information and image information corresponding to the visible image to be provided to the rendering.

13. The rendering control device according to claim 12, wherein
the discoloration information contains color information before rendering corresponding to a color of the recording medium before the rendering and color information after rendering corresponding to a state in which a degree of change of the color by the rendering has progressed to a preset progress degree, comprising:
a color difference information generation device which generates color difference information by detecting a difference between the color indicated by the color information before rendering and the color indicated by the color information after rendering;
a determination device which determines whether or not the rendering on the recording medium having a color difference indicated by the color difference information is appropriate based on the generated color difference information; and
a notification device which makes a notification of inappropriateness when the rendering is determined not to be appropriate.

14. The rendering control device according to claim 13, further comprising
a comparison device which compares an area of a dark portion region that is a region on the recording medium corresponding to a dark portion in the visible image with an area of a bright portion region that is a region on the recording medium corresponding to a bright portion in the visible image if continuation of the rendering is instructed even after the notification of inappropriateness is made, wherein
the control information generating device generates the control information to control an irradiation position of a light beam on the recording medium so that the light beam for the rendering is shone on the region of the smaller area of the dark portion region and the bright portion region to be provided to the rendering.

15. The rendering control device according to claim 12, wherein
the discoloration information contains also intermediate color information indicating the color appearing on the recording medium in a process of discoloration from the color of the recording medium before the rendering to the color corresponding to the state in which the degree of change of the color by the rendering has progressed to the preset progress degree in corresponding to the progress of the rendering, and
the control information generating device generates the control information so that at least one of intensity of the light beam for the rendering and a number of times of the rendering for the same position on the recording medium is controlled based on the intermediate color information contained in the acquired discoloration information to be provided to the rendering.

16. The rendering control device according to claim 12, further comprising:
a gray scale determination device which determines whether or not a gray scale in the visible image can be represented by a change in a range of the change in the color indicated by the acquired discoloration information based on the image information; and
an image information correction device which corrects the image information so that, when it is determined that the gray scale cannot be represented by the change in the range, a darkest color in the visible image corresponds to the color belonging to one end of the range and a brightest color in the visible image corresponds to the color belonging to another end of the range based on the image information so as to generate correction image information, wherein
the image information generating device generates the control information based on the generated correction image information to be provided to the rendering.

17. The rendering control device according to claim 12, further comprising
a display device which displays the visible image to be rendered based on the generated control information before performing the rendering using the generated control information.

18. The rendering control device according to claim 12, wherein
the discoloration information corresponding to the recording medium is recorded in the recording medium itself in advance, and
the acquisition device is a detection device which detects the discoloration information from the recording medium in which the discoloration information is recorded.

19. The recording medium on which the discoloration information is recorded detectably by the detection device in the rendering control device according to claim 18, wherein
the discoloration information is recorded in a position on the recording medium where the discoloration information can be detected before the rendering on the recording medium.

20. The rendering control device according to claim 12, further comprising
a discoloration information storage device which stores the discoloration information corresponding to the rendering control device in advance, wherein
the acquisition device is a reading device which reads the discoloration information from the discoloration information storage device.

21. A rendering device, comprising:
an acquisition device which acquires the control information generated by the rendering control device according to claim 12; and
an emission device which emits a light beam for the rendering based on the acquired control information.

22. A recording medium in which a program for rendering control is computer-readably recorded, said program causing a computer to function as the rendering control device according to claim 12.
